(19) United States
(12) Patent Application Publication
(10) Pub. No.: US 2026/0160109 A1
(43) Pub. Date: Jun. 11, 2026

(54) FRICTION BRAKE DEVICE AND VEHICLE DOOR SUPPORT MEMBER

(71) Applicant: U-Shin Ltd., Nagano (JP)

(72) Inventors: Mikio YAMAGATA, Hiroshima (JP); Toshiyuki YAHARI, Hiroshima (JP)

(21) Appl. No.: 19/400,024

(22) Filed: Nov. 25, 2025

(30) Foreign Application Priority Data
Dec. 6, 2024 (JP) 2024-214005

(51) Int. Cl. E05F 15/622

(52) U.S. Cl. CPC E05F 15/622; E05Y 2201/21; E05Y 2201/266; E05Y 2900/546

(57) ABSTRACT

A friction brake device includes a rotor pair including a brake rotor connectable to a first rotary element and a slip rotor connectable to a second rotary element, a torsion coil spring having a coil portion wound around an outer periphery of the rotor pair, a ring member surrounding the coil portion, a brake case rotatably accommodating the rotor pair, the torsion coil spring, and the ring member, and a friction generating element non-rotatably accommodated in the brake case. When one rotor is rotationally driven, the coil portion comes into pressure contact with the inner peripheral surface of the ring member, and the ring member rotates integrally with the rotor pair and comes into sliding contact with the friction generating element. When the other rotor is rotationally driven, the coil portion releases or reduces pressure contact with the inner peripheral surface of the ring member.

### CROSS REFERENCE TO RELATED APPLICATION

This application claims benefit of priority to Japanese Patent Application 2024-214005, filed on Dec. 6, 2024, the entire content of which is incorporated herein by reference.

### BACKGROUND ART

### Technical Field

The present invention relates to a friction brake device and a vehicle door support member.

### Background Art

U.S. Pat. No. 11,067,156 B2 discloses a friction brake device applicable to a vehicle door support member. A vehicle door support member includes a fixed housing that rotatably supports a spindle and a movable housing to which a spindle nut screwed with the spindle and guided to translate in an axial direction is coupled. One of these housings is connected to the vehicle body, and the other is connected to the door. When the door is caused to perform an opening operation or a closing operation, translation of the spindle nut is converted into rotation of the spindle, and the movable housing advances or retracts with respect to the fixed housing.

A friction brake device includes a rotor pair including a slip rotor that rotates integrally with a spindle and a brake rotor that rotatably supports the slip rotor, a torsion coil spring wound around the rotor pair, and a brake case that accommodates the rotor pair and the torsion coil spring. The coil portion of the torsion coil spring is enlarged or reduced in diameter according to the operation mode of the door, whereby whether or not to apply the rotational resistance to the spindle is mechanically switched.

In the case of U.S. Pat. No. 11,067,156 B2, the diameter of the coil portion is increased according to the closing operation of the door, and the coil portion rotates together with the rotor pair while being in sliding contact with the brake case. As a result, rotational resistance is applied. On the other hand, the diameter of the coil portion is reduced according to the opening operation of the door. Therefore, the rotational resistance is not applied or is reduced as compared with the time of the closing operation.

### SUMMARY

It is difficult to configure the friction brake device so that whether or not to apply the rotational resistance is appropriately switched according to the expansion/contraction of the coil portion. For example, when the pressure contact force to the brake case becomes excessive at the time of expanding the diameter of the coil portion, there is a possibility that the slip rotor and the brake rotor cannot rotate with an appropriate force, that is, the door cannot be operated with an appropriate force.

An object of the present invention is to provide a friction brake device capable of appropriately applying rotational resistance, and a vehicle door support member including the friction brake device.

According to one aspect of the present invention, there is provided a friction brake device, including: a rotor pair including a brake rotor having a first connecting portion connectable to an external first rotary element and a slip rotor having a second connecting portion connectable to an external second rotary element and rotatably accommodated in the brake rotor; a torsion coil spring having a coil portion wound around an outer periphery of the rotor pair and a pair of end portions extending from both ends of the coil portion and engaged to the rotor pair; a ring member surrounding the coil portion; a brake case that rotatably accommodates the rotor pair, the torsion coil spring, and the ring member; and a friction generating element that is non-rotatably accommodated in the brake case and slidably contacts an outer peripheral surface of the ring member, in which when one rotor of the rotor pair is rotationally driven, the coil portion comes into pressure contact with an inner peripheral surface of the ring member, and the ring member rotates integrally with the rotor pair and comes into sliding contact with the friction generating element, and when the other rotor of the rotor pair is rotationally driven, the coil portion releases or reduces pressure contact of the ring member with the inner peripheral surface.

According to the above configuration, the rotor pair is configured to be connectable to the first rotary element and the second rotary element. The operation of the coil portion changes depending on which of the one rotor and the other rotor is rotationally driven, and the pressure contact force of the coil portion with respect to the ring member changes. Accordingly, whether or not to apply the rotational resistance is mechanically switched depending on which of the one rotor and the other rotor is rotationally driven.

The coil portion itself that performs the operation for switching is not a main generation source of the rotational resistance. The element (coil portion) that performs the operation for switching is separated from the element (ring member and friction generating element) that generates rotational resistance when necessary. The coil portion only needs to be able to make pressure contact with the ring member so as to be able to exert a sufficiently large frictional force for corotation with the ring member when rotational resistance is to be applied. The element that performs the operation for switching and the element that generates the rotational resistance can be optimally designed so that the operation required for each element can be performed. Compared to a case where the coil portion is required not only to switch but also to generate the rotational resistance, it is possible to relatively easily realize the friction brake device capable of appropriately applying the rotational resistance.

When the friction brake device is used, both the first rotary element and the second rotary element may not necessarily be connected to the rotor pair. One rotary element may be connected to the connecting portion of one rotor, and the connecting portion of the other rotor may not be connected to the rotary element.

Another aspect of the present invention provides a vehicle door support member including: the friction brake device described above; a tubular fixed housing having a first end connected to one of a vehicle body and a door and a second end opposite to the first end; a tubular movable housing that has a third end connected to the other of the vehicle body and the door, has a side opposite to the third end accommodated in the fixed housing from the second end, and is movable in an axial direction with respect to the fixed housing; a spindle rotatably supported within the fixed housing; and a spindle nut screwed to the spindle and coupled to the movable housing, in which the spindle is one of the first rotary element and the second rotary element, and is connected to the one rotor of the rotor pair.

According to the above configuration, when one rotor is rotationally driven by the spindle, that is, when the user manually operates the door, the rotational resistance can be appropriately applied to the spindle.

According to the present invention, it is possible to provide a friction brake device capable of appropriately applying rotational resistance, and a vehicle door support member including the friction brake device.

### BRIEF DESCRIPTION OF DRAWINGS

FIG. 1 is a perspective view of a vehicle including a vehicle door support member to which a friction brake device according to an embodiment of the present invention is applied;

FIG. 2 is a longitudinal sectional view of a vehicle door support member according to the first embodiment of the present invention;

FIG. 3 is an exploded perspective view of the vehicle door support member of FIG. 2;

FIG. 4 is an exploded perspective view of the friction brake device of FIG. 2;

FIG. 5 is an exploded perspective view of the friction brake device of FIG. 4 as viewed from above;

FIG. 6 is an exploded perspective view of the friction brake device of FIG. 4 as viewed from below;

FIG. 7 is an exploded perspective view of a slip rotor, a brake rotor, a torsion coil spring, a ring member, and a friction generating element in FIG. 4 as viewed from above;

FIG. 8 is an exploded perspective view of the slip rotor, the brake rotor, the torsion coil spring, the ring member, and the friction generating element in FIG. 4 as viewed from below;

FIG. 9 is an axis-orthogonal cross-sectional view of the friction brake device of FIG. 2;

FIG. 10 is an exploded perspective view of a friction brake device according to a modification;

FIG. 11 is an axis-orthogonal cross-sectional view of a brake case, a slip rotor, a torsion coil spring, a ring member, and a friction generating element of the friction brake device of FIG. 10; and

FIG. 12 is a longitudinal sectional view of a vehicle door support member according to a second embodiment of the present invention.

### DETAILED DESCRIPTION

Hereinafter, embodiments will be described with reference to the drawings. Note that the same or corresponding elements are denoted by the same reference numerals throughout the drawings, and overlapping of detailed description will be omitted. In the following description, the friction brake device, the vehicle door support member, and the vehicle door support device according to the embodiments are simply referred to as a brake, a support member, and a support device, respectively.

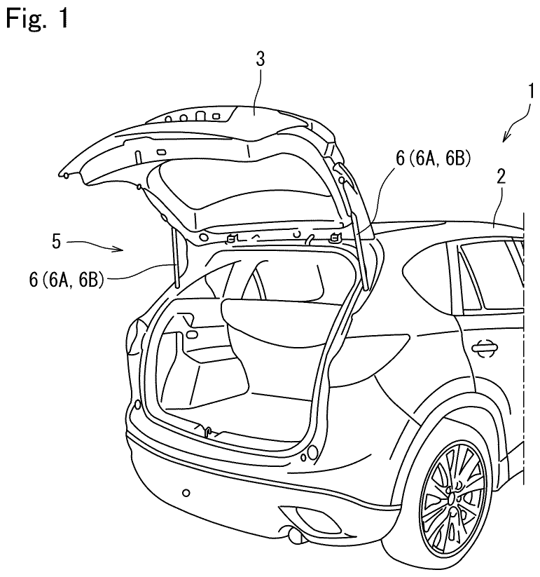

Referring to FIG. 1, a support device 5 and a support member 6 provided in the support device 5 are applied to a vehicle 1, and support a door 3 with respect to a vehicle body 2. The support member 6 has a rod shape, and has one end connected to the vehicle body 2 and the other end connected to the door 3. The support member 6 extends in conjunction with the opening operation of the door 3 and contracts in conjunction with the closing operation of the door 3.

There are two types of support members 6: an active type and a passive type. An active type support member 6A can be actively extended and contracted by the driving force of the built-in motor, thereby operating the door 3. A passive type support member 6B does not include a motor and extends and contracts following the operation of the door 3.

The support device 5 includes a pair of support members 6. The pair may have two active types, two passive types, or one active type and one passive type. In the case of one active type and one passive type, when the motor is operated, the active type support member 6A actively extends and contracts to operate the door 3, and the passive type support member 6B extends and contracts following the operation of the door 3. When the user manually operates the door 3, both the active type and the passive type extend and contract following the operation. Even in a case where the support device 5 includes two active types, the active type support member 6A passively extends and contracts at the time of manual operation.

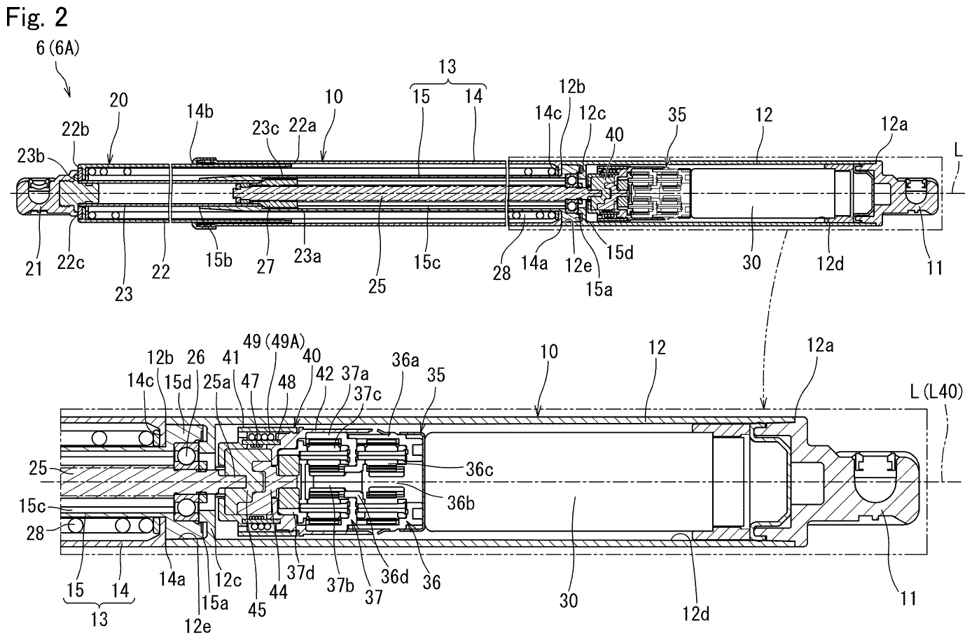

The brake 40 is applicable to the active type support member 6A (see FIG. 2). The brake 40 exerts a braking force against the passive extension and contraction, but does not exert or reduces the braking force against the active extension and contraction. The brake 40 can mechanically switch the presence or absence (or magnitude) of the braking force depending on whether the extension and contraction is active or passive.

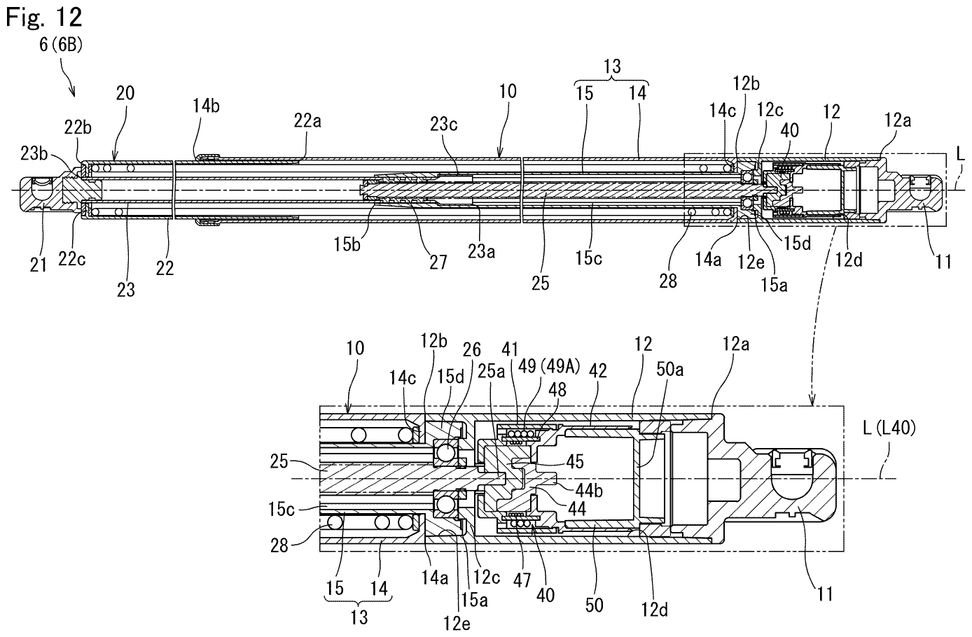

The brake 40 is also applicable to the passive type support member 6B (see FIG. 12). In the passive type, since extension and contraction are always passive, braking force is always exerted at the time of extension and contraction. Although the brake 40 does not exert the switching function, it is advantageous in that the brake 40 of the support member 6B can be shared with the brake 40 of the support member 6A.

Hereinafter, as a first embodiment, an active type support member 6A with a brake 40 will be described. Next, as a second embodiment, a passive type support member 6B including a brake 40 having the same configuration as that of the first embodiment will be described.

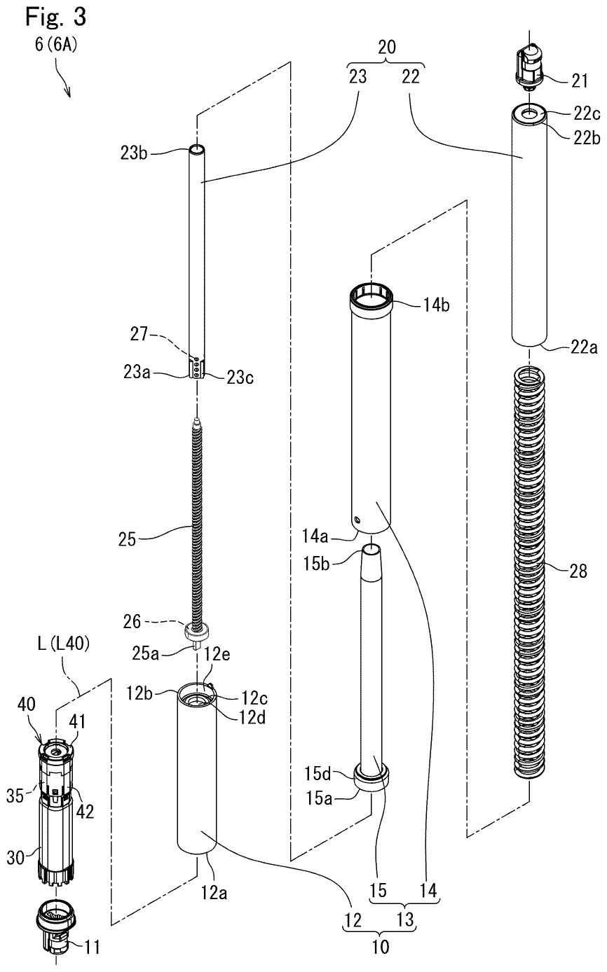

Referring to FIGS. 2 and 3, the support member 6A according to the first embodiment includes a fixed housing 10, a movable housing 20, a spindle 25, a spindle nut 27, a coil spring 28, a motor 30, a speed reducer 35, and a brake 40. These members are disposed coaxially with each other, and an axis common to these members forms a central axis L of the support member 6A.

The fixed housing 10 and the movable housing 20 are tubular, typically cylindrical. The fixed housing 10 has a first end connected to the vehicle body and a second end opposite to the first end. The movable housing 20 has a third end connected to the door. The movable housing 20 is accommodated in the fixed housing 10 from the second end and is movable in the axial direction with respect to the fixed housing 10. The spindle 25 is rotatably supported in the fixed housing 10. The spindle nut 27 is screwed to the spindle 25 and coupled to the movable housing 20. The coil spring 28 biases the movable housing 20 in a direction to advance from the fixed housing 10. FIG. 2 illustrates a state in which the movable housing 20 is most advanced.

In the following description, with respect to the axial direction of the support member 6A, a side approaching a connection partner of the fixed housing 10 is referred to as a “proximal end side”, and a side away from the connection partner of the fixed housing 10 is referred to as a “terminal end side”. In the present embodiment, the vehicle body side is the proximal end side. However, the first end may be connected to the door, and the third end may be connected to the vehicle body. In this case, the door side is the proximal end side.

The fixed housing 10 has a cylindrical accommodating portion 12 and an extension portion 13 extending from the accommodating portion 12 to the terminal end side. The extension portion 13 has a double cylindrical shape, and has a cover portion 14 on the outer side and a guide portion 15 on the inner side.

The accommodating portion 12 is opened at a proximal end 12a and a terminal end 12b. The proximal end 12a is closed by a connecting member 11 and is swingably connected to the vehicle body 2 (see FIG. 1) via the connecting member 11. The connecting member 11 protrudes from the fixed housing 10 to the proximal end side. The accommodating portion 12 has an annular partition plate portion 12c protruding from a terminal end portion of the inner peripheral surface. The accommodating portion 12 has a holding portion 12d on the proximal end side with respect to the partition plate portion 12c, and has an attachment recess 12e on the terminal end side with respect to the partition plate portion 12c. The point that the holding portion 12d holds the brake 40 will be described later.

The guide portion 15 is opened at a proximal end 15a and a terminal end 15b. A cylindrical attachment portion 15d protruding radially outward is provided at the proximal end 15a. The attachment portion 15d is fitted into the attachment recess 12e and fixed to the accommodating portion 12 by, for example, laser welding.

The cover portion 14 is opened at a proximal end 14a and a terminal end 14b. An annular plate-shaped support portion 14c protruding radially inward is provided at the proximal end 14a. The proximal end surface of the support portion 14c is supported by the attachment portion 15d. The cover portion 14 extends from the accommodating portion 12 to the terminal end side such that the outer peripheral surface of the cover portion 14 and the outer peripheral surface of the accommodating portion 12 are continuous in the axial direction.

The movable housing 20 has a double cylindrical shape, and has an outer cylinder 22 on the outer side and a push rod 23 on the inner side. The outer cylinder 22 is opened at a proximal end 22a and a terminal end 22b. An annular plate-shaped support portion 22c protruding radially inward is provided at the terminal end 22b. The push rod 23 is opened at a proximal end 23a and a terminal end 23b. The terminal end 23b is located inside the support portion 22c. The terminal ends 22b and 23b are closed by a connecting member 21, and are swingably connected to the door 3 (see FIG. 1) via the connecting member 21. The connecting member 21 is, for example, a ball socket, and protrudes from the movable housing 20 to the terminal end side.

The proximal end 12a of the accommodating portion 12 is an example of a first end. The terminal ends 14b and 15b of the cover portion 14 and the guide portion 15 are examples of a second end. The terminal ends 22b and 23b of the outer cylinder 22 and the push rod 23 are examples of a third end.

The proximal end side of the movable housing 20 is accommodated in the fixed housing 10 from the terminal ends 14b and 15b. The outer cylinder 22 is fitted into the cover portion 14, and the push rod 23 is inserted into the guide portion 15. The guide portion 15 has a plurality of guide grooves 15c extending in the axial direction on the inner peripheral surface thereof, and the push rod 23 has a plurality of guide projections 23c on the proximal end 23a. The plurality of guide projections 23c are fitted into the plurality of guide grooves 15c, respectively.

The spindle 25 is rotatably supported around the central axis L by the bearing 26 held by the attachment portion 15d and the partition plate portion 12c, and extends in the axial direction inside the guide portion 15 and the push rod 23. The spindle nut 27 is coupled to the proximal end 23a of the push rod 23 and screwed with the spindle 25 inside the guide portion 15. The spindle nut 27 is supported so as to be non-rotatable and movable in the axial direction with respect to the guide portion 15 by the engagement of the guide projection 23c and the guide groove 15c. The guide projection may be provided on the spindle nut 27.

The coil spring 28 is accommodated in a compressed state inside the cover portion 14 and the outer cylinder 22 and outside the guide portion 15 and the push rod 23. The coil spring 28 extends in the axial direction, and has a proximal end supported by the support portion 14c and a terminal end supported by the support portion 22c. The cover portion 14 is brought into pressure contact with the accommodating portion 12 and the attachment portion 15d by a spring force.

The accommodating portion 12 has an internal space defined by the partition plate portion 12c and the holding portion 12d. The spindle 25 protrudes from the bearing 26 toward the proximal end side, passes through the partition plate portion 12c, and enters the accommodating portion 12. The spindle 25 has a connection shaft portion 25a accommodated inside the accommodating portion 12 at a proximal end thereof.

In the accommodating portion 12, particularly in the holding portion 12d, the motor 30, the speed reducer 35, and the brake 40 are arranged in this order from the proximal end side toward the terminal end side along the axial direction. The motor 30 is a DC motor that can rotate forward and backward. The speed reducer 35 includes two-stage planetary gear mechanisms 36 and 37, and each stage includes internal gears 36a and 37a, sun gears 36b and 37b, planetary gears 36c and 37c, and planetary carriers 36d and 37d. The internal gears 36a and 37a are fixed. The output shaft of the motor 30 is coupled to the first-stage sun gear 36b, the first-stage planetary carrier 36d is coupled to the second-stage sun gear 37b, and the second-stage planetary carrier 37d is coupled to the brake 40 from the proximal end side. The connection shaft portion 25a is also connected to the brake 40 from the terminal end side.

When the user manually causes the opening operation or the closing operation to occur, the movable housing 20 is pulled out or pushed into the fixed housing 10 following the operation. The push rod 23 moves axially with the spindle nut 27. The linear movement of the spindle nut 27 is converted into the rotation of the spindle 25, and the rotation is input to the brake 40. The brake 40 applies rotational resistance to the spindle 25.

When the motor 30 operates, the rotation of the motor 30 is decelerated at each stage of the speed reducer 35. The rotation of the speed reducer 35 is transmitted to the connection shaft portion 25a via the brake 40, and the spindle 25 rotates. The rotation of the spindle 25 is converted into linear movement of the spindle nut 27. The spindle nut 27 is guided by the guide portion 15 together with the push rod 23 to move in the axial direction. The movable housing 20 is pushed out or pulled in with respect to the fixed housing 10, and an opening operation or a closing operation occurs. The brake 40 does not apply or reduces rotational resistance to the spindle 25.

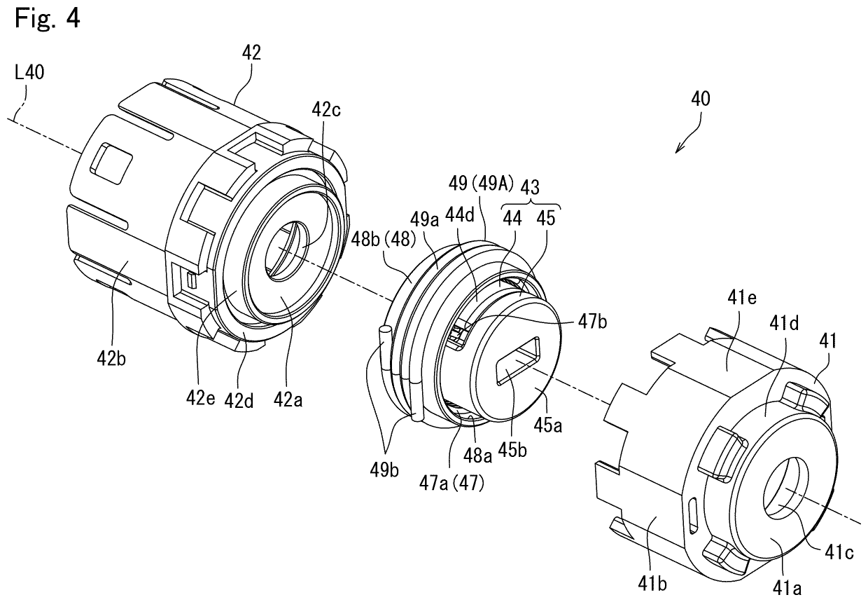

Referring to FIGS. 2 and 4, the brake 40 includes a brake case 41, a brake cover 42, a slip rotor 44, a brake rotor 45, a torsion coil spring 47, a ring member 48, and a second torsion coil spring 49A as a friction generating element 49. These members are disposed coaxially with each other, and an axis common to these members forms a central axis L40 of the brake 40. The central axis L40 coincides with the central axis L of the support member 6A.

The brake case 41, the brake cover 42, the slip rotor 44, and the brake rotor 45 are resin molded products. The torsion coil spring 47, the ring member 48, and the second torsion coil spring 49A are made of metal. The ring member 48 may be made of a sintered material in order to suppress the progress of wear.

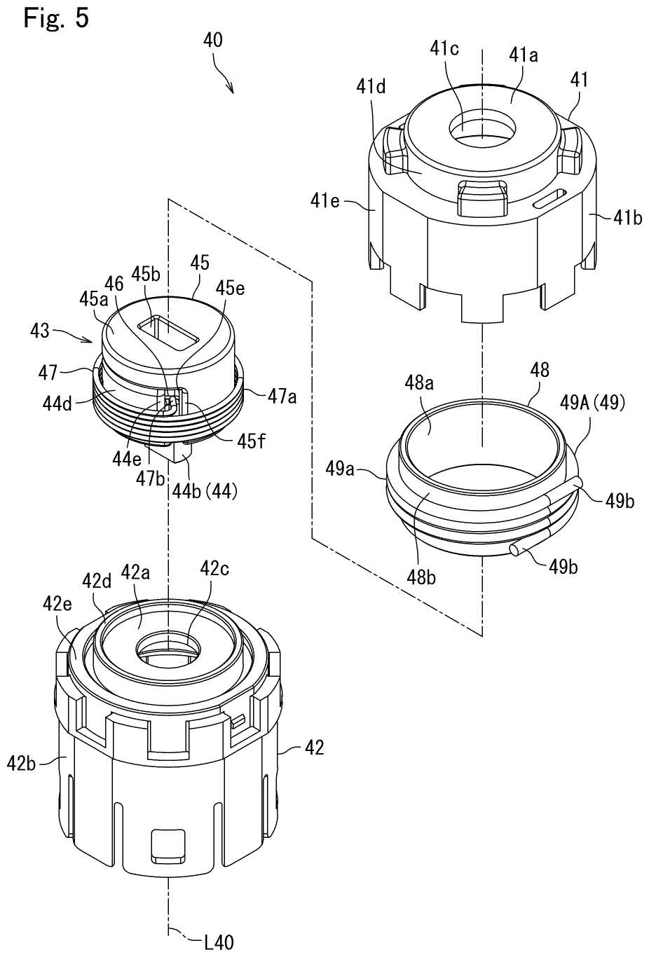

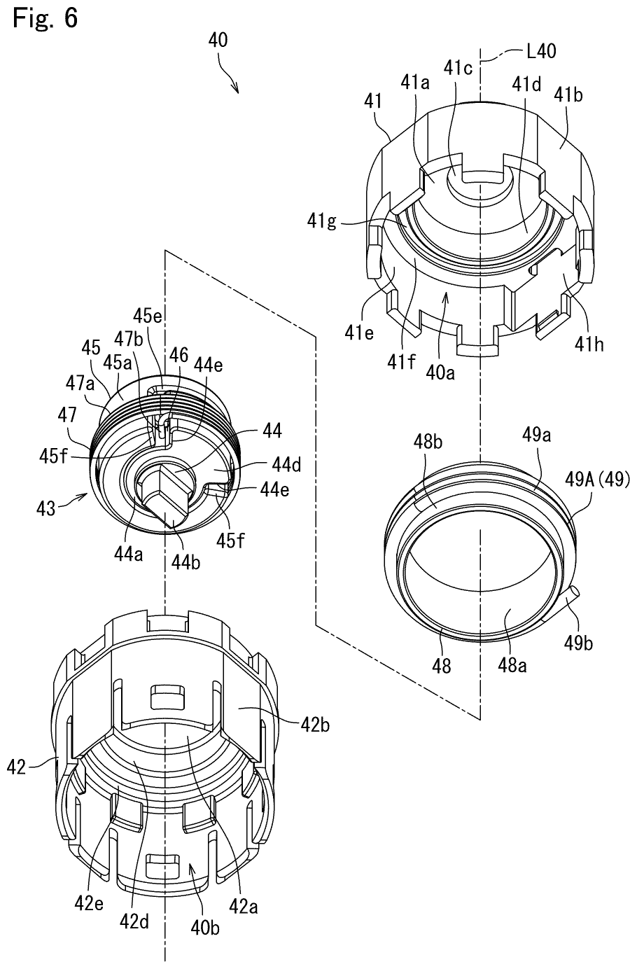

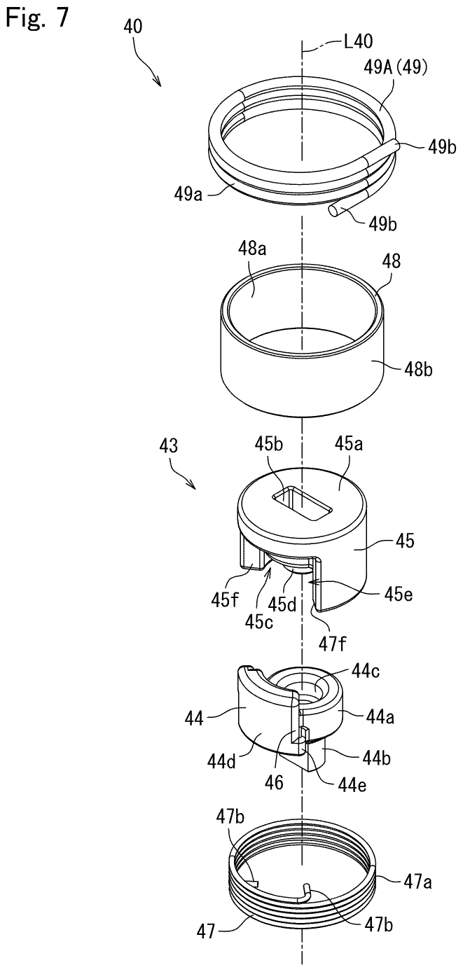

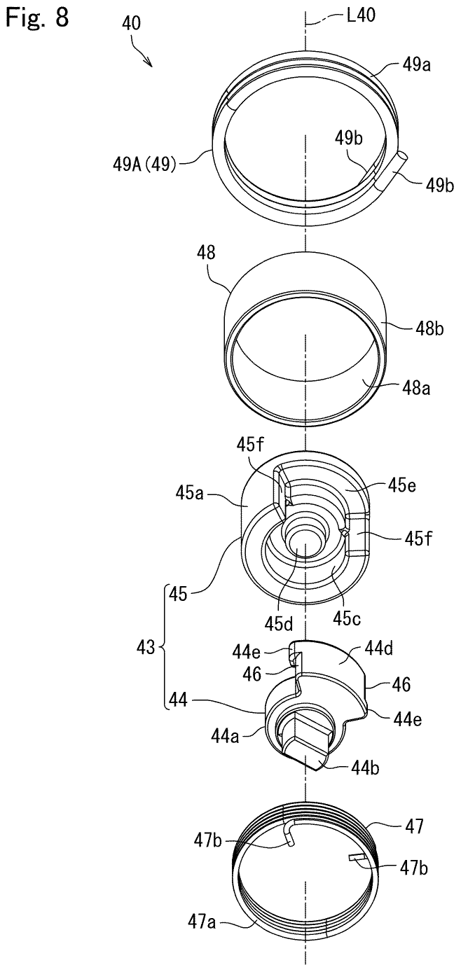

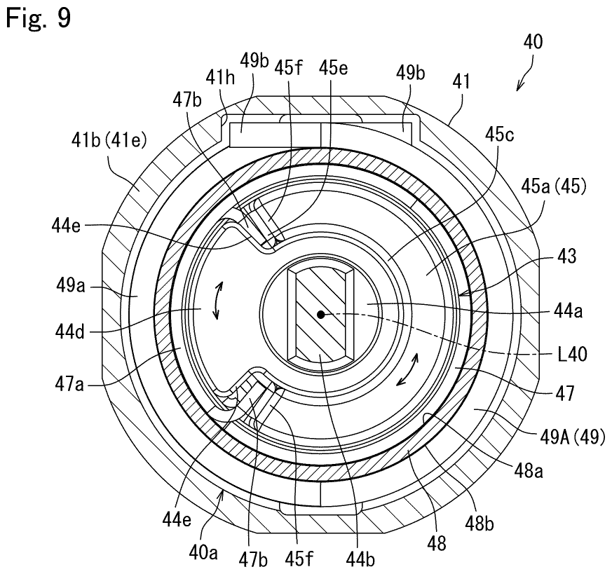

Referring to FIGS. 4 to 9, the brake case 41 and the brake cover 42 have a tubular shape opened at the proximal end. The brake case 41 has an end wall 41a on the terminal end side and a peripheral wall 41b extending from the end wall 41a toward the proximal end side. The brake cover 42 also has an end wall 42a on the terminal end side and a peripheral wall 42b extending from the end wall 42a toward the proximal end side. When the brake case 41 and the brake cover 42 are assembled to each other, the peripheral walls 41b and 42b are continuous in the axial direction, and the proximal end of the brake case 41 is closed by the end wall 42a of the brake cover 42.

The outer peripheral surfaces of the peripheral walls 41b and 42b are non-cylindrical surfaces. The brake case 41 and the brake cover 42 are fitted into the proximal end portion of the holding portion 12d and are non-rotatably attached to the fixed housing 10. The end walls 41a and 42a and the peripheral wall 41b constitute a first accommodating portion 40a. The first accommodating portion 40a is adjacent to the proximal end side of the partition plate portion 12c. The end wall 42a and the peripheral wall 42b constitute a second accommodating portion 40b. The second accommodating portion 40b is adjacent to the proximal end side of the first accommodating portion 40a via the end wall 42a.

The first accommodating portion 40a accommodates a rotor pair 43 (the slip rotor 44 and the brake rotor 45), the torsion coil spring 47, and the ring member 48 so as to be rotatable about the central axis L40. The first accommodating portion 40a non-rotatably accommodates the friction generating element 49 (second torsion coil spring 49A). The second accommodating portion 40b accommodates the speed reducer 35.

The end wall 41a is provided with a through hole 41c for connecting the brake rotor 45 to the spindle 25. The end wall 42a is provided with a through hole 42c for connecting the slip rotor 44 to the motor 30.

The slip rotor 44 and the brake rotor 45 are assembled to each other to constitute the rotor pair 43. The brake rotor 45 has a first connecting portion 45b that enables connection with a first rotary element outside the brake 40. The slip rotor 44 has a second connecting portion 44b that enables connection with a second rotary element outside the brake 40.

In the present embodiment, the first connecting portion 45b is disposed on the terminal end side of the rotor pair 43, and the second connecting portion 44b is disposed on the proximal end side of the rotor pair 43. The first rotary element is a spindle 25. The second rotary element is the motor 30 or the speed reducer 35 connected thereto, more specifically, an output shaft (that is, the shaft portion of the planetary carrier 37d) of the speed reducer 35.

The slip rotor 44 includes a base portion 44a rotatable around the central axis L40 and a protruding portion 44d protruding radially outward from the base portion 44a. The base portion 44a has a bottomed cylindrical shape opened at the terminal end. The base portion 44a defines a shaft hole 44c for assembly with the brake rotor 45. The protruding portion 44d has a sector shape when viewed in the axial direction, and protrudes outward from the outer peripheral surface of the base portion 44a. The outer peripheral surface of the protruding portion 44d is a partial cylindrical surface.

The second connecting portion 44b protrudes from the base portion 44a toward the proximal end side, and can be connected to a female connected portion. In this example, such a connected portion is provided at the terminal end of the output shaft of the speed reducer 35. The second connecting portion 44b and the connected portion have non-circular (for example, a rectangular shape) cross sections complementary to each other, thereby allowing torque to be transmitted from the motor 30 to the slip rotor 44. However, the second connecting portion 44b and the connected portion may be reversed in male and female.

The brake rotor 45 includes a cylindrical rotor body 45a opened at a proximal end. The rotor body 45a has an end wall portion at a terminal end and a peripheral wall portion extending from the end wall portion to the proximal end side. The first connecting portion 45b is a groove or a hole opened to the terminal end surface of the end wall portion of the rotor body 45a, and can be connected to a male connected portion. In this example, the connection shaft portion 25a of the spindle 25 is the connected portion. The first connecting portion 45b and the connection shaft portion 25a have mutually complementary non-circular (for example, a rectangular shape) cross-sections, thereby allowing the transmission of torque from the spindle 25 to the brake rotor 45 or vice versa. A knurl may be applied for connection between the first connecting portion 45b and the connection shaft portion 25a.

The rotor body 45a has an accommodating portion 45c. The accommodating portion 45c is a space defined by the inner surfaces of the end wall portion and the peripheral wall portion, and is opened at the proximal end. The rotor body 45a is provided with a shaft portion 45d protruding from the end wall portion to the accommodating portion 45c. The rotor body 45a is provided with a limiting groove 45e that opens the accommodating portion 45c radially outward. The limiting groove 45e is formed by cutting out a part of the peripheral wall portion in the circumferential direction from the proximal end to the terminal end side, and does not reach the terminal end of the peripheral wall portion.

The accommodating portion 45c accommodates the base portion 44a. The shaft portion 45d is inserted into the shaft hole 44c, and the slip rotor 44 is rotatably supported with respect to the brake rotor 45. Note that the diameter of the accommodating portion 45c (the inner diameter of the rotor body 45a) is as small as possible within a range allowing rotation of the base portion 44a of the slip rotor 44. On the other hand, the protruding portion 44d does not fit in the accommodating portion 45c and is disposed in the limiting groove 45e. The outer peripheral surface of the protruding portion 44d is exposed radially outward and forms the appearance of the rotor pair 43. The outer diameter of the protruding portion 44d is equal to the outer diameter of the rotor body 45a. The angular range (width in the circumferential direction) of the limiting groove 45e is wider than the angular range (width in the circumferential direction) of the protruding portion 44d. Therefore, the limiting groove 45e can accommodate the protruding portion 44d, and the slip rotor 44 and the brake rotor 45 can relatively rotate by the difference in the angular range.

Here, an end portion of the protruding portion 44d in the circumferential direction (width direction) is referred to as a “side portion 44e”. A portion that is a part of the peripheral wall portion of the rotor body 45a and defines both ends of the limiting groove 45e in the circumferential direction (width direction) is referred to as a “groove side wall 45f”. Due to the above-described difference in the angular range, the rotor pair 43 has a pair of gaps between the one side portion 44e and the groove side wall 45f opposed thereto and between the other side portion 44e and the groove side wall 45f opposed thereto.

When the slip rotor 44 is rotationally driven, one of the pair of side portions 44e abuts on the groove side wall 45f facing the side portion according to the rotation direction. Thereafter, the slip rotor 44 rotates integrally with the brake rotor 45. When the brake rotor 45 is rotationally driven, one of the pair of groove side walls 45f abuts on the side portion 44e facing the groove side wall according to the rotation direction. Thereafter, the brake rotor 45 rotates integrally with the slip rotor 44.

The torsion coil spring 47 includes a coil portion 47a wound around the outer peripheral side of the rotor pair 43 and a pair of end portions 47b extending from both ends of the coil portion 47a. The coil portion 47a has a spiral shape and is wound around the rotor pair 43 in a region where the protruding portion 44d is disposed in the axial direction. Both ends of the coil portion 47a and a pair of end portions 47b continuous thereto are separated not only in the axial direction but also in the circumferential direction. The pair of end portions 47b linearly extends radially inward from the coil portion 47a and is accommodated in the pair of gaps described above, thereby being engaged to the rotor pair 43. The torsion coil spring 47 is attached to the rotor pair 43 in a compressed state from a natural state.

When the slip rotor 44 is rotationally driven, the end portion 47b is pushed by the side portion 44e. When the brake rotor 45 is rotationally driven, the end portion 47b is pushed by the groove side wall 45f. The coil portion 47a is wound around the rotor pair 43 in a winding direction in which a force is exerted in a direction in which the coil portion 47a is pushed by the end portion 47b to expand the diameter when the end portion 47b is pushed by the brake rotor 45. Conversely, the coil portion 47a is wound around the rotor pair 43 in a winding direction in which a force is exerted in a direction in which the coil portion 47a is pulled by the end portion 47b to reduce the diameter when the end portion 47b is pushed by the slip rotor 44.

A pair of recesses 46 is provided in each of the pair of side portions 44e, whereby the pair of gaps described above is partially widened. The pair of end portions 47b is not sandwiched between the rotor pair 43 during the integral rotation of the rotor pair 43, and is received by each of the pair of recesses 46. The pair of recesses 46 is provided at different positions in the axial direction due to a difference in axial positions of the pair of end portions 47b. The one recess 46 extends from the proximal end of the protruding portion 44d to the terminal end side to accommodate the end portion 47b on the proximal end side. The other recess 46 extends from the terminal end of the protruding portion 44d to the proximal end side to accommodate the end portion 47b on the terminal end side. The recess 46 may be provided in the groove side wall 45f.

The ring member 48 has a cylindrical shape opened at both ends. The inner peripheral surface 48a and the outer peripheral surface 48b of the ring member 48 are both cylindrical surfaces. The inner diameter and the outer diameter of the ring member 48 are both constant in the axial direction. The ring member 48 is externally fitted to the coil portion 47a. The inner peripheral surface of the ring member 48 is in contact with the coil portion 47a.

The second torsion coil spring 49A includes a second coil portion 49a wound around the outer peripheral side of the ring member 48 and a pair of second end portions 49b extending from both ends of the second coil portion 49a. The second coil portion 49a has a spiral shape and is in contact with the outer peripheral surface 48b of the ring member 48. Both ends of the second coil portion 49a are separated in the axial direction, but are substantially at the same position in the circumferential direction. The pair of second end portions 49b linearly extends on opposite sides to each other along a tangent line at positions at both ends of the second coil portion 49a in the circumferential direction.

The rotor pair 43, the torsion coil spring 47, the ring member 48, and the second torsion coil spring 49A are accommodated in the first accommodating portion 40a via the proximal end opening of the brake case 41 in a state where the brake cover 42 is detached from the brake case 41. Thereafter, the brake cover 42 is assembled to the brake case 41, and the proximal end opening of the brake case 41 is closed.

Specifically describing the assembly procedure, first, the friction generating element 49 is attached to the outer periphery of the ring member 48, and the torsion coil spring 47 is attached to the inner periphery of the ring member 48. Next or simultaneously, the brake rotor 45 is attached to the brake case 41. Next, the ring member 48 with the torsion coil spring 47 and the friction generating element 49 is assembled to the brake case 41 with the brake rotor 45. Finally, the slip rotor 44 is assembled to the brake rotor 45, and the torsion coil spring 47 and the rotor pair 43 are simultaneously assembled to each other. Thus, the assembly of the brake 40 is completed. The exploded views of FIGS. 4 to 6 are intended to clearly show the positional relationship between the rotor pair 43 and the torsion coil spring 47 and the positional relationship between the ring member 48 and the friction generating element 49, and do not necessarily show the process in the middle of the assembly procedure.

The brake case 41 has a stepped cylindrical shape. The terminal end side is a small cylindrical portion 41d having a relatively small diameter, and the proximal end side is a large cylindrical portion 41e having a relatively large diameter. The brake case 41 is provided with a stepped portion 41f connecting the small cylindrical portion 41d and the large cylindrical portion 41e in the radial direction, and the stepped portion 41f has an annular shape when viewed in the axial direction. A circular groove 41g is provided on an inner surface of the stepped portion 41f. A rectangular limiting recess 41h is provided on the inner peripheral surface of the large cylindrical portion 41e. The axial length of the limiting recess 41h is longer than the axial length of the second torsion coil spring 49A.

The terminal end portion of the brake cover 42 has a double cylindrical shape. The inner cylinder portion 42d on the inner peripheral side protrudes to the proximal end side from the outer cylinder portion 42e on the outer peripheral side. The end wall 42a protrudes radially inward from the inner peripheral surface in the vicinity of the terminal end of the inner cylinder portion 42d.

The rotor pair 43 is accommodated in the brake case 41 in a posture in which the first connecting portion 45b faces the terminal end side and the second connecting portion 44b faces the proximal end side. The rotor body 45a is accommodated in the small cylindrical portion 41d, and the base portion 44a is accommodated in the inner cylinder portion 42d. As a result, the rotor pair 43 is rotatably supported around the central axis L40 with respect to the brake case 41 and the brake cover 42.

The female first connecting portion 45b is exposed to the terminal end side through the through hole 41c. The connection shaft portion 25a enters the first accommodating portion 40a through the through hole 41c and is connected to the first connecting portion 45b. As a result, the spindle 25 is fixed coaxially with respect to the rotor pair 43. The male second connecting portion 44b passes through the end wall 42a through the through hole 42c of the end wall 42a, enters the second accommodating portion 40b, and is connected to the connected portion of the output shaft of the speed reducer 35. As a result, the output shaft of the speed reducer 35 is coaxially fixed to the rotor pair 43.

The terminal end portion of the ring member 48 is located on the proximal end side with respect to the terminal end of the rotor body 45a and is inserted into the circular groove 41g. The terminal end portion of the ring member 48 is located on the proximal end side with respect to the proximal end of the base portion 44a (the root of the second connecting portion 44b), and is externally fitted to the inner cylinder portion 42d and internally fitted to the outer cylinder portion 42e. Thus, the ring member 48 is rotatably supported around the central axis L40 with respect to the brake case 41 and the brake cover 42. Most of the ring member 48 is surrounded by the large cylindrical portion 41e.

The torsion coil spring 47 is wound around and engaged to the rotor pair 43, is completely covered by the ring member 48, and is accommodated inside the large cylindrical portion 41e. When neither the slip rotor 44 nor the brake rotor 45 is rotationally driven, that is, when the rotor pair 43 is at the neutral position, the coil portion 47a abuts on the inner peripheral surface of the ring member 48.

The second coil portion 49a of the second torsion coil spring 49A is disposed between the outer peripheral surface 48b of the ring member 48 and the inner peripheral surface of the large cylindrical portion 41e. The second end portion 49b is accommodated in the limiting recess 41h. Circumferential displacement of the second torsion coil spring 49A is prevented by contact between the second end portion 49b and the limiting recess 41h. In a state where the second end portion 49b is engaged to the brake case 41, the second torsion coil spring 49A is non-rotatably accommodated in the first accommodating portion 40a with respect to the brake case 41.

In the support member 6A including the brake 40 configured as described above, when the user manually causes the opening operation to occur, the spindle 25 rotates in the opening direction according to the pull-out of the movable housing 20. Accordingly, the brake rotor 45 is rotationally driven in the opening direction by the spindle 25. Before the brake rotor 45 rotates integrally with the slip rotor 44, the end portion 47b of the torsion coil spring 47 is pushed by the brake rotor 45, and the coil portion 47a is pushed by the end portion 47b. The coil portion 47a exerts a force to expand the diameter, and is brought into pressure contact with the inner peripheral surface 48a of the ring member 48 by the force. By this pressure contact, the ring member 48 rotates with respect to the brake case 41 integrally with the rotor pair 43 together with the torsion coil spring 47. At this time, the ring member 48 rotates while bringing its outer peripheral surface into sliding contact with the second coil portion 49a of the second torsion coil spring 49A. The second torsion coil spring 49A generates friction with the ring member 48, and this friction is applied as rotational resistance to the spindle 25 via the ring member 48, the torsion coil spring 47, and the rotor pair 43. In this manner, the brake 40 exerts the braking force with respect to the manual opening operation.

When the user manually causes the closing operation to occur, the spindle 25 rotates in the closing direction in response to the pushing of the movable housing 20. Accordingly, the brake rotor 45 is rotationally driven in the closing direction by the spindle 25. Thereafter, the operation is similar to the manual opening operation. The end portion 47b is pressed by the brake rotor 45, the coil portion 47a is brought into pressure contact with the ring member 48, the ring member 48 rotates integrally with the rotor pair 43 and comes into sliding contact with the second torsion coil spring 49A, and the second torsion coil spring 49A applies rotational resistance to the spindle 25. In this manner, the brake 40 exerts the braking force with respect to the manual closing operation.

Next, when the opening operation is caused to occur by the driving force of the motor 30, the slip rotor 44 is rotationally driven in the opening direction by the motor 30 to push out the movable housing 20. Before the slip rotor 44 rotates integrally with the brake rotor 45, the end portion 47b of the torsion coil spring 47 is pushed by the slip rotor 44, and the coil portion 47a is pulled by the end portion 47b. The coil portion 47a exerts a force for reducing the diameter, thereby eliminating or reducing the pressure contact force to the inner peripheral surface 48a of the ring member 48. Therefore, during the integral rotation of the rotor pair 43, the rotor pair 43 and the torsion coil spring 47 rotate freely with respect to the ring member 48 or while lightly sliding on the inner peripheral surface 48a of the ring member 48. The ring member 48 is kept fixed to the brake case 41. Therefore, the second torsion coil spring 49A does not generate friction with the ring member 48 and does not apply rotational resistance to the spindle 25. Depending on the situation, the friction generated between the torsion coil spring 47 and the ring member 48 may be applied to the spindle 25 as a braking force, but is small compared to the rotational resistance generated by manual operation.

When the closing operation is caused to occur by the driving force of the motor 30, the slip rotor 44 is rotationally driven in the closing direction by the motor 30 to pull in the movable housing 20. Thereafter, the same operation as the opening operation by the motor 30 is performed. The end portion 47b is pushed by the slip rotor 44, the pressure contact force of the coil portion 47a with respect to the ring member 48 disappears or decreases, the ring member 48 does not come into sliding contact with the second torsion coil spring 49A, and the second torsion coil spring 49A does not apply rotational resistance to the spindle 25.

As described above, the operation of the coil portion 47a changes depending on which of the rotor pair 43 is rotationally driven, and the pressure contact force of the coil portion 47a with respect to the ring member 48 changes. Accordingly, whether or not to apply the rotational resistance is mechanically switched. The coil portion 47a itself that performs the operation for switching is not a main generation source of the rotational resistance. The element that performs the operation for switching (the coil portion 47a) is separated from the element that generates rotational resistance when necessary (the ring member 48 and the friction generating element 49). It is sufficient that the coil portion 47a can be brought into pressure contact with the ring member 48 so as to exert a sufficiently large frictional force for corotation with the ring member 48 when applying the rotational resistance. As compared with the case where the coil portion 47a not only performs the operation for switching but also generates the rotational resistance, the brake 40 capable of appropriately applying the rotational resistance can be realized relatively easily.

In any of the above four operations, the end portion 47b is received in the recess 46. The load acting on the end portion 47b from the rotor pair 43 can be reduced. The service life of the torsion coil spring 47 and thus the brake 40 becomes long.

The friction generating element 49 is a second torsion coil spring 49A surrounding the ring member 48. As a result, the contact area and the pressure contact force with the ring member 48 can be adjusted with a simple structure, and appropriate rotational resistance can be easily applied.

The pair of second end portions 49b of the second torsion coil spring 49A extends opposite to each other along the tangential direction at a certain position in the circumferential direction of the second coil portion 49a. As a result, protrusion of the second end portion 49b from the second coil portion 49a can be suppressed, and downsizing of the brake 40 can be realized.

When the rotor pair 43 is at the neutral position, the torsion coil spring 47 comes into contact with the inner peripheral surface 48a of the ring member 48. Accordingly, it is possible to achieve both generation of a pressure contact force for corotating the ring member 48 when the diameter of the coil portion 47a is increased and appropriate reduction of friction between the torsion coil spring 47 and the ring member 48 when the diameter of the coil portion 47a is reduced.

The outer peripheral surface 48b and the inner peripheral surface 48a of the ring member 48 are cylindrical surfaces. Accordingly, a pressure contact force for corotation can be received from the coil portion 47a in the entire circumferential direction. During the rotation of the ring member 48, the entire outer peripheral surface 48b in the circumferential direction can be brought into sliding contact with the friction generating element. Therefore, the rotational resistance can be appropriately applied.

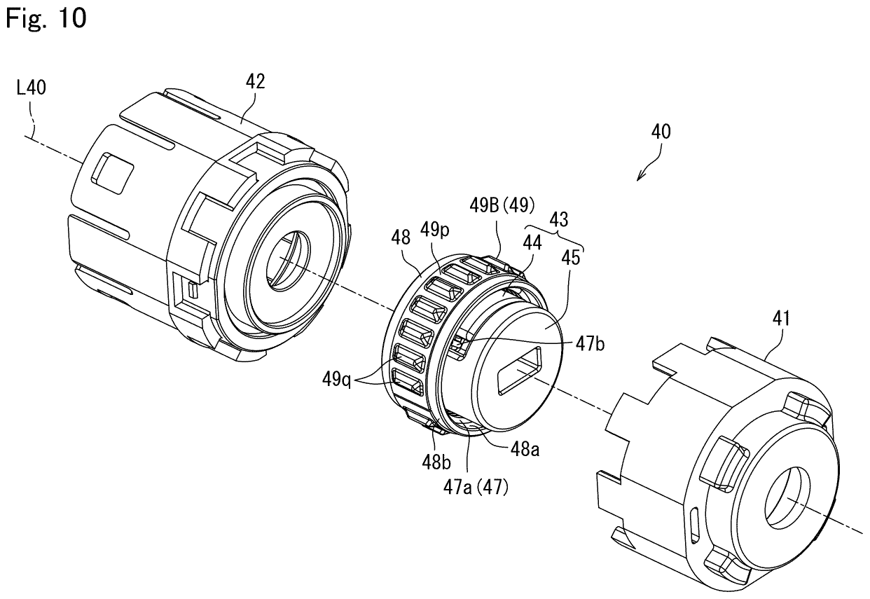

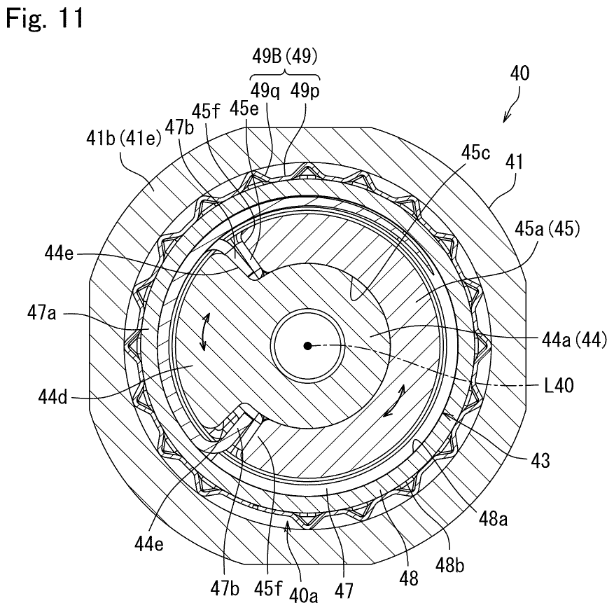

Next, a modification of the brake 40 will be described with reference to FIGS. 10 and 11.

The brake 40 according to the modification includes a tolerance ring 49B as the friction generating element 49. The tolerance ring 49B includes a cylindrical or drum-shaped ring body 49p and a plurality of elastic protrusions 49q provided on an outer peripheral surface of the ring body 49p. The elastic protrusion 49q is a protrusion extending in the axial direction and is elastically deformable in the radial direction. The plurality of elastic protrusions 49q are arranged on the outer peripheral surface of the ring body 49p at intervals in the circumferential direction.

The inner peripheral surface of the tolerance ring 49B is in contact with the outer peripheral surface 48b of the ring member 48. The plurality of elastic protrusions 49q of the tolerance ring 49B are brought into pressure contact with the inner peripheral surface of the large cylindrical portion 41e of the brake case 41 in a state of being elastically deformed radially inward. As a result, the tolerance ring 49B is accommodated non-rotatably with respect to the brake case 41. The inner peripheral surface of the large cylindrical portion 41e of the brake case 41 is a cylindrical surface to support the plurality of elastic protrusions 49q in the entire circumferential direction. In the brake 40 according to the modification, the limiting recess 41h of the above embodiment is omitted.

Even when the brake 40 according to the modification is applied to the support member 6A, the brake 40 operates similarly to the above embodiment. That is, while the brake 40 applies the rotational resistance to the spindle 25 during the manual operation, the brake 40 does not apply or reduces the rotational resistance to the spindle 25 during the operation by the motor 30.

Next, a support member 6B according to a second embodiment will be described with reference to FIG. 12.

The support member 6B does not include the motor 30 and the speed reducer 35. Therefore, the accommodating portion 12 is shorter than the support member 6A. As the accommodating portion 12 is shortened, the partition plate portion 12c, the attachment portion 15d, and the support portion 14c are located on the proximal end side, and the extension portion 13 becomes longer. The spindle 25 becomes longer on the terminal end side with respect to the bearing 26, and the coil spring 28 becomes longer. A brake 40 and a spacer 50 are disposed in the accommodating portion 12. The spacer 50 is disposed on the proximal end side of the brake 40. The spacer 50 has a cylindrical shape, and includes a reinforcing partition wall 50a on the proximal end side. The second connecting portion 44b of the slip rotor 44 has no connection partner.

Also in the present embodiment, when the brake rotor 45 is rotationally driven by the spindle 25, the brake 40 can apply rotational resistance to the spindle 25. The second torsion coil spring 49A or the tolerance ring 49B may be applied to the friction generating element 49.

The configuration of the above embodiment is merely an example, and can be appropriately changed within the scope of the present invention.

The slip rotor 44 may be connected to the spindle 25, and the brake rotor 45 may be connected to the speed reducer 35 and thus the motor 30. In this case, the winding direction of the coil portion 47a is opposite to that of the above embodiment. This makes it possible to apply rotational resistance at the time of passive extension and contraction, and eliminate or reduce the rotational resistance at the time of active extension and contraction.

The end portion 47b of the torsion coil spring 47 may be provided only at one end of the coil portion 47a. In this case, the recess 46 that accommodates the end portion 47b may be provided in the corresponding one of the side portions 44e of the protruding portion 44d of the slip rotor 44 or the corresponding one of the groove side walls 45f of the limiting groove 45e of the brake rotor 45.

The first rotary element is not limited to the spindle 25 of the support member 6A, and the second rotary element is not limited to the motor 30 of the support member 6A. The friction brake device may be applied to equipment other than the vehicle door support device.

What is claimed is

1. A friction brake device, comprising:
a rotor pair including a brake rotor having a first connecting portion connectable to an external first rotary element and a slip rotor having a second connecting portion connectable to an external second rotary element and rotatably accommodated in the brake rotor;
a torsion coil spring having a coil portion wound around an outer periphery of the rotor pair and a pair of end portions extending from both ends of the coil portion and engaged to the rotor pair;
a ring member surrounding the coil portion;
a brake case that rotatably accommodates the rotor pair, the torsion coil spring, and the ring member; and
a friction generating element that is non-rotatably accommodated in the brake case and slidably contacts an outer peripheral surface of the ring member, wherein
when one rotor of the rotor pair is rotationally driven, the coil portion comes into pressure contact with an inner peripheral surface of the ring member, and the ring member rotates integrally with the rotor pair and comes into sliding contact with the friction generating element, and
when the other rotor of the rotor pair is rotationally driven, the coil portion releases or reduces pressure contact of the ring member with the inner peripheral surface.

2. The friction brake device according to claim 1, wherein the friction generating element is a second torsion coil spring surrounding the ring member.

3. The friction brake device according to claim 2, wherein
the second torsion coil spring has a second coil portion wound around the outer peripheral surface of the ring member, and a pair of second end portions extending from both ends of the second coil portion and engaged to the brake case, and
the pair of second end portions extends opposite to each other along a tangential direction at a certain position in a circumferential direction of the second coil portion.

4. The friction brake device according to claim 1, wherein the friction generating element is a tolerance ring that elastically contacts the ring member and the brake case.

5. The friction brake device according to claim 1, wherein the torsion coil spring contacts the inner peripheral surface of the ring member when the rotor pair is in a neutral position.

6. The friction brake device according to claim 2, wherein the torsion coil spring contacts the inner peripheral surface of the ring member when the rotor pair is in a neutral position.

7. The friction brake device according to claim 3, wherein the torsion coil spring contacts the inner peripheral surface of the ring member when the rotor pair is in a neutral position.

8. The friction brake device according to claim 4, wherein the torsion coil spring contacts the inner peripheral surface of the ring member when the rotor pair is in a neutral position.

9. The friction brake device according to claim 1, wherein the outer peripheral surface and the inner peripheral surface of the ring member are cylindrical surfaces.

10. The friction brake device according to claim 2, wherein the outer peripheral surface and the inner peripheral surface of the ring member are cylindrical surfaces.

11. The friction brake device according to claim 3, wherein the outer peripheral surface and the inner peripheral surface of the ring member are cylindrical surfaces.

12. The friction brake device according to claim 4, wherein the outer peripheral surface and the inner peripheral surface of the ring member are cylindrical surfaces.

13. The friction brake device according to claim 5, wherein the outer peripheral surface and the inner peripheral surface of the ring member are cylindrical surfaces.

14. A vehicle door support member, comprising:
a friction brake device;
a tubular fixed housing having a first end connected to one of a vehicle body and a door and a second end opposite to the first end;
a tubular movable housing that has a third end connected to the other of the vehicle body and the door, has a side opposite to the third end accommodated in the fixed housing from the second end, and is movable in an axial direction with respect to the fixed housing;
a spindle rotatably supported within the fixed housing; and
a spindle nut screwed with the spindle and coupled to the movable housing,
the friction brake device comprising:
a rotor pair including a brake rotor having a first connecting portion connectable to an external first rotary element and a slip rotor having a second connecting portion connectable to an external second rotary element and rotatably accommodated in the brake rotor;
a torsion coil spring having a coil portion wound around an outer periphery of the rotor pair and a pair of end portions extending from both ends of the coil portion and engaged to the rotor pair;
a ring member surrounding the coil portion;
a brake case that rotatably accommodates the rotor pair, the torsion coil spring, and the ring member; and
a friction generating element that is non-rotatably accommodated in the brake case and slidably contacts an outer peripheral surface of the ring member, wherein
when one rotor of the rotor pair is rotationally driven, the coil portion comes into pressure contact with an inner peripheral surface of the ring member, and the ring member rotates integrally with the rotor pair and comes into sliding contact with the friction generating element,
when the other rotor of the rotor pair is rotationally driven, the coil portion releases or reduces pressure contact of the ring member with the inner peripheral surface, and
the spindle is one of the first rotary element and the second rotary element, and is connected to the one rotor of the rotor pair.

15. The vehicle door support member according to claim 14, further comprising a motor that drives the spindle, wherein
the motor is the other of the first rotary element and the second rotary element, and is connected to the other rotor of the rotor pair.
